(19) United States
(12) Patent Application Publication
(10) Pub. No.: US 2007/0250389 A1
(43) Pub. Date: Oct. 25, 2007

(54) Gift card donation method

(76) Inventor: George C. Holtz, Milwaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/787,358

(22) Filed: Apr. 16, 2007

Related U.S. Application Data
(60) Provisional application No. 60/744,948, filed on Apr. 17, 2006.

(51) Int. Cl. G06Q 30/00

(52) U.S. Cl. 705/14

(57) ABSTRACT

A method comprising the steps of: receiving at least one gift card, each gift card having an outstanding balance; consolidating the outstanding balances to a consolidated gift card; selling said consolidated gift card; collecting revenue generated from selling the consolidated gift card; and giving at least a portion of the revenue to a community group.

### CROSS-REFERENCE TO RELATED APPLICATIONS

This application claims priority to and the benefit of U.S. provisional application Ser. No. 60/744,948, filed on Apr. 17, 2006, incorporated herein in its entirety.

### FIELD OF INVENTION

This invention relates to the field of gift cards, and more specifically to a method of donating unused or unwanted gift card balances to a community group.

### BRIEF DESCRIPTION OF THE DRAWINGS

FIG. 1 is flow chart explaining one embodiment of the gift card donation method according to the instant invention.

FIG. 2 is a flow chart showing one alternate embodiment of the gift card donation method according to the instant invention, further including one embodiment of the consolidating step.

FIG. 3 is a flow chart showing one alternate embodiment of the gift card donation method according to the instant invention, further including the step of selling the newly issued gift card for an amount less than its face value.

### BACKGROUND

It has been estimated that $60 billion is spent on gift cards annually, and a significant percentage of issued gift cards go unused or are only partially used. Depending on the on the policies of the gift card issuer, unused gift card balances may be lost after a certain period of time or may be redeemed for their value only if the gift card holder to makes an additional purchase beyond the face value of the gift card. Additionally, gift cards are generally redeemable only by the issuer (or by entities affiliated or approved by the issuer) regardless of whether the gift card holder or recipient actually desires to purchase merchandise or services from the issuing entity.

In addition, when a gift card is purchased, the issuing entity may be required to keep the gift card balance on their books until the balance is redeemed.

With respect to the present invention, the following terms are used to describe exemplary embodiments of the invention:

As used herein, the term “community group” refers to any organization, institution, corporation, individual, or other entity, whether non-profit or for-profit, created for any purpose involving the generation of and/or raising of capital.

As used herein, the term “issuing entity” refers to a business or provider of goods and services which issues gift cards redeemable for its goods and services.

As used herein, the term “facilitator” refers to any person, device, organization, or entity that is responsible for performing, leading, or coordinating the method according to the instant invention.

As used herein, the term “card” or “gift card” refers to any data or datum capable of associating a monetary or credit value with a particular customer and/or transaction, and which contains data indicating the dollar value and transaction terms for which the certificate will be accepted by a participating vendor. A certificate may be a paper certificate, an electronically transmitted file such as an e-mail or file maintained on a computer or terminal, checking account information, a credit card number, other account number, a gift card, a rechargeable gift card, a token, a numeric code, a bar code, bio-informatics data, a code word, a digital signature, a sequence known to the purchaser or vendor, or other data capable of being associated with a commercial transaction, including combinations thereof.

As used herein, the term “donated gift card” refers to a card or gift which has been donated or gifted to a community group or for a designated cause or purpose.

As used herein, the term “consolidated gift card” refers to a gift card which has an economic value based on the sum or combined value of at least two donated cards or gift cards.

As used herein, the term “discounted price” refers to an amount less than the consolidated face value of a gift card.

As used herein, the term “card revenue” refers to an amount paid for a consolidated gift card, which amount may be more less or equal to the consolidated face value of the gift card.

As used herein, the term “individual redemption value” refers to the redemption value of an individual gift card prior to any calculation based on consolidating the value of the individual gift card with another card.

As used herein, the term “face value” refers to any monetary amount assigned to the card which may be applied to the purchase of good and services by vendors. The face value may be more, less or equal to the discounted price or card revenue.

As used herein, an the term “issuing mechanism” refers to any device or containing information relating to authorizing and issuing one or more consolidated gift cards including a memory device, keyboard, a typewriter, cash register, a touch-sensitive computer interface, a voice recognition device, the certificate itself, a paper document, and combinations thereof. a wireless device, laptop computer, mobile phone, personal information device, personal digital assistant, hand-held device, network appliance, pager, an analog device or a device used manually, microphones, touch-sensitive displays, transducer card readers, magnetic or paper tape readers, tablets, styluses, voice or handwriting recognizers, a server, a mechanism capable of reading biological information, a document reader or scanner, any other recording device commonly known and used in the art, and including combinations thereof.

### DETAILED DESCRIPTION OF EMBODIMENTS OF THE INVENTION

For the purpose of promoting an understanding of the present invention, references will be made in the text hereof to embodiments of a gift card donation method. It is to be understood, however, that the present invention may be embodied in various forms. Therefore, specific details disclosed herein are not to be interpreted as limiting, but rather as a basis for the claims and as a representative basis for teaching one skilled in the art to employ the present invention. One of ordinary skill in the art will readily appreciate that modifications do not depart from the spirit and scope of the present invention, some of which are mentioned in the following description.

With particular reference to the figures, the reader should also know that like numerals in different figures refer to the same elements of the embodiments. Moreover, it should be noted that each embodiment of the gift card donation method is not depicted by the figures. In addition, additional and/or equivalent steps can be included without departing from the spirit and scope of the invention.

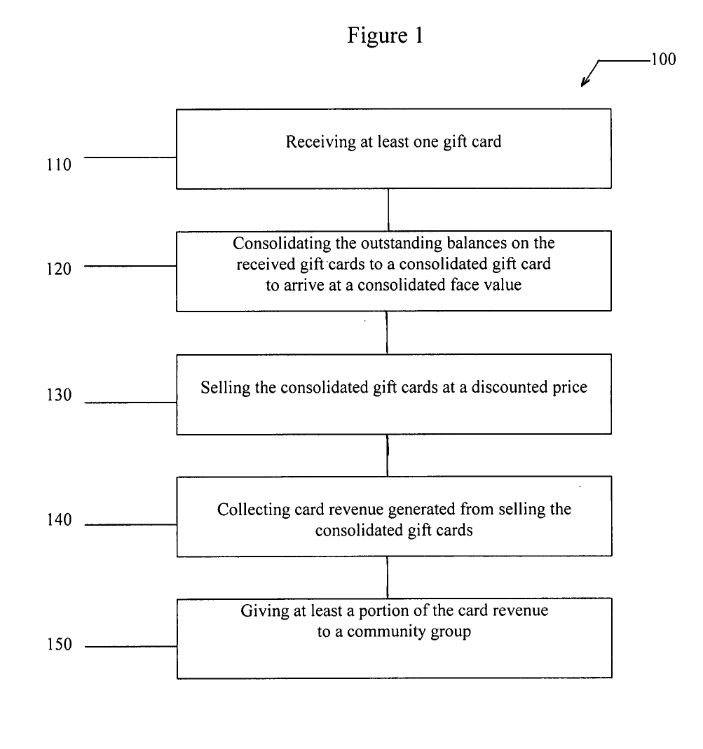

Referring now to the figures, FIG. 1 is flow chart explaining one embodiment of gift card donation method 100 according to the instant invention. In the embodiment shown, gift card donation method 100 is comprised of the steps of: receiving at least one gift card 110 in which each donated gift card has an unused or outstanding balance; consolidating the outstanding balances from the gift cards to a consolidated gift card to arrive at a consolidated face value 120; selling the consolidated gift card at discounted price 130; collecting card revenue generated from selling the consolidated gift card for the discounted price 140; and giving at least a portion of the card revenue to a community group 150. According to one embodiment of the instant invention, method 100 is performed by a facilitator. The facilitator can be a single entity or can be multiple entities, and the facilitator can perform all steps of method 100, or facilitator can perform any portion of the steps, including zero (0) and control and/or direct one or more other entities to perform any portion of the steps, either individually or in concert with the other entities.

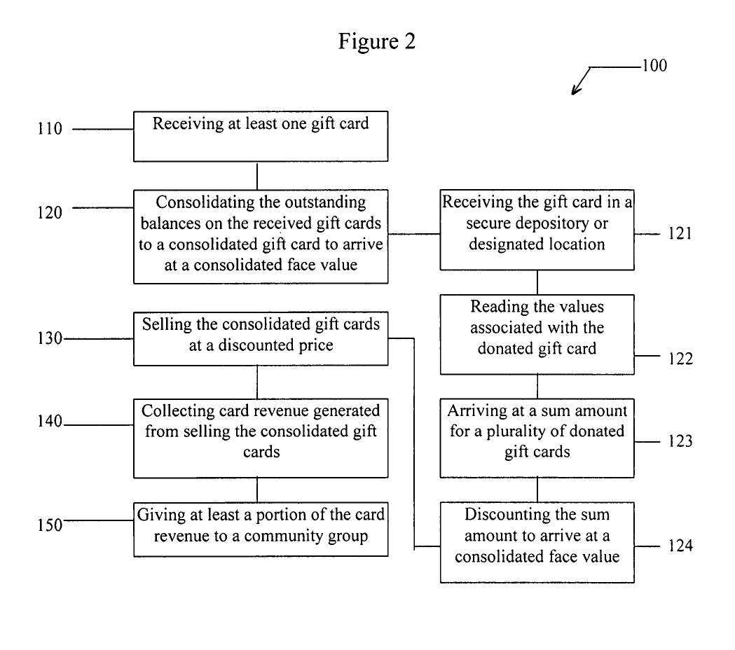

FIG. 2 shows an additional embodiment of the invention. In this embodiment, a facilitator may maintain information about the redemption or other relevant policies of an issuing entity, participating community groups or other data on 100 on a computer readable medium, database or server. The computer readable medium may include cooperating or interconnected computer readable medium, which exist exclusively on the processing system or be distributed among multiple interconnected processing systems that may be local or remote to the processing system

In the step of receiving at least one gift card 110, the facilitator collects donated gift cards. The donated gift cards can be collected directly from the gift card holders or a separate entity can receive the donated gift cards and provide them to the facilitator. In the embodiment shown, a community group collects partially used and unused gift cards as part of a typical fundraising campaign. Either at the end of or during the fundraising campaign, the community group provides the donated gift cards to the facilitator who receives them. The consolidated face value of the consolidated gift card may be more, less or equal to the individual redemption value of the donated gift cards.

Method 100 further includes the step of consolidating the outstanding balances on the received gift cards to a consolidated give card to arrive at a consolidated face value 120. One embodiment of step 120, consolidating the outstanding balances to a consolidated gift card, includes receiving the card in a secure depository or designated location 121, reading the values associated with the donated gift card by any means 122, included but not limited a bar code reader, scanner or sensor, associating values with each donated gift card, arriving at a sum amount for a plurality of donated gift cards 123, and discounting the sum amount to arrive at a consolidated face value 124, as shown in FIG. 2.

Method 100 further includes the step of selling the consolidated gift cards at a discounted price 130, i.e., the consolidated face value of step 124 referred to supra. In step 130, the consolidated gift cards are sold to consumers. The step of selling the consolidated gift card at a discounted price 130 can be performed in any manner commonly known in the art using any issuing mechanism. For example, the consolidated gift cards can be sold at stores, can be purchased from members of the community group, can be auctioned, can be sold as part of the same or another fundraising campaign, or can be sold on-line. Furthermore, the consolidated gift cards 130 can be sold at any value. Specifically, in one embodiment of method 100, the consolidated gift cards are sold at seventy five percent (75%) of their face value. In an alternate embodiment, the consolidated gift cards are sold on-line and at eighty to ninety percent (80-90%) of their face value. However, it should be understood that any reduction in the cost to purchase the consolidated gift cards can be used and that in an alternate embodiment, the consolidated gift cards can be sold at face value.

Method 100 further includes the step of collecting the card revenue generated from selling the consolidated gift cards 140. In step 140, the facilitator collects the proceeds from the selling of the consolidated gift cards. The proceeds can be collected in any manner commonly used in the art. For example, if the consolidated gift cards are sold on-line, any electronic method of payment may be accepted or the consolidated gift card can be send to the purchaser once a check is received. In yet another embodiment, if the consolidated gift cards are sold as part of a fundraising campaign or at a store, cash, check, or credit or debit card can be used for payment.

Method 100 further includes the step of giving at least a portion of the card revenue to the community group 150. In step 150, at least a portion of the revenue generated from the sales of the consolidated gift cards is given to the community group. The exact amount is determined by an agreement between the facilitator and the community group and can be one hundred percent (100%) of the proceeds is that is the agreed upon amount. In one embodiment, the facilitator gives the community group fifty to sixty percent (50-60%) of the proceeds from the sale of the consolidated gift cards and keeps the remaining forty to fifty percent (40-50%).

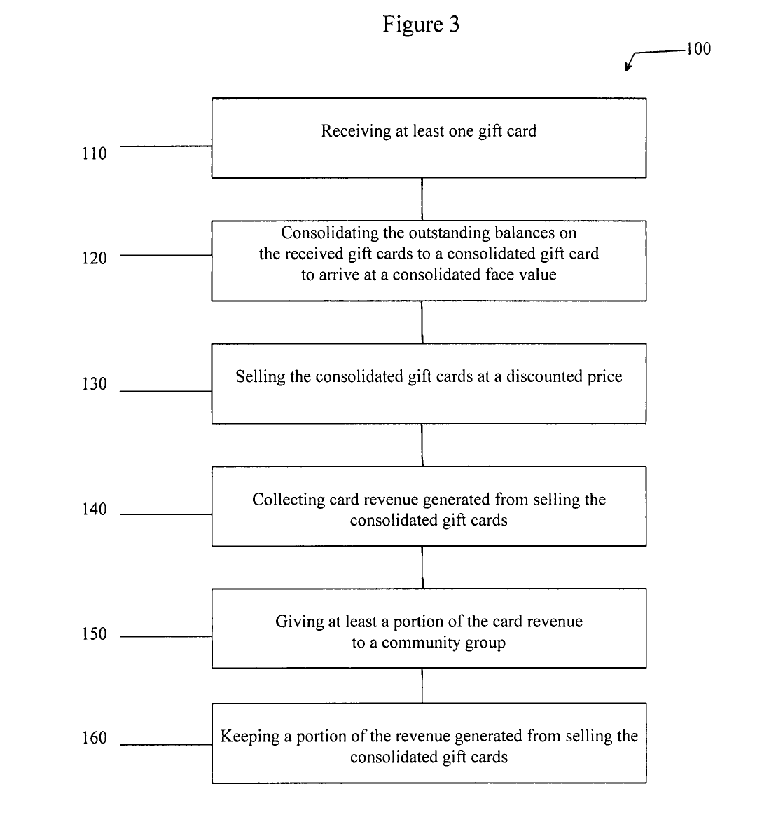

FIG. 3 is a flow chart showing another alternate embodiment of gift card donation method 100 according to the instant invention, further including Step 160 of keeping a portion of the revenue generated from selling the consolidated gift cards. In this embodiment, gift card donation method 100 is comprised of the steps of: receiving at least one gift card 110, in which each gift card has an unused or outstanding balance; consolidating the outstanding balances of the received gift cards to a consolidated gift card 120 to arrive at a consolidated face value; selling the consolidated gift card at a discounted price 130; collecting the revenue generated from selling the consolidated gift card 140; and giving at least a portion of the revenue to a community group 150, but further shows the step of keeping a portion of the revenue generated from selling the consolidated gift cards 160.

While the gift card donation method has been shown and described with respect to several embodiments in accordance with the present invention, it is to be understood that the same is not limited thereto, but is susceptible to numerous changes and modifications as known to a person skilled in the art, and it is intended that the present invention not be limited to the details shown and described herein, but rather cover all such changes and modifications as are obvious to one of ordinary skill in the art.

1. A method comprising the steps of:
receiving at least one gift card, each of said at least one gift card having an outstanding balance;
consolidating at least one of said outstanding balance to a consolidated gift card
selling said consolidated gift card;
collecting a card revenue generated from said selling said consolidated gift card; and
giving at least a portion of said revenue to a community group.

2. The method of claim 1, wherein said method is performed by a facilitator, said facilitator selected from a group comprised of a single entity and a plurality of entities.

3. The method of claim 2, wherein said facilitator performs all steps of said method, said facilitator performs a first portion of said method and directs one or more other entities to perform a second portion of said method, or said facilitator direct one or more other entities to perform said method.

4. The method of claim 1, wherein said selling said consolidated gift card step is performed at a discounted price.

5. The method of claim 1, wherein said consolidating the outstanding balances to a consolidated gift card step is performed by a method comprising the steps of: receiving each of said at least one gift card in a secure depository or designated location; reading a value associated with each of said at least one gift card, arriving at a sum gift card value for a plurality of said at least one gift card; associating at least one sum gift card value with each of said at least one gift card; and discounting said sum gift card value to arrive at a consolidated gift card face value.

6. The method of claim 1, wherein said selling said consolidated gift card step is performed by a method selected from a group comprised of selling said consolidated gift card at a store, selling said consolidated gift card to at least one member of said community group, auctioning said consolidated gift card, and selling said consolidated gift card as part of a promotional campaign in which said at least one gift card was received, and selling said consolidated gift card on-line.

7. The method of claim 1, wherein said consolidated gift card is sold at a discounted value between approximately fifty percent and approximately ninety-nine percent of said consolidated gift card's value.

8. A method comprising the steps of:
receiving at least one gift card, each of said at least one gift card having an outstanding balance;
consolidating at least one of said outstanding balance to a consolidated gift card
selling said consolidated gift card at a discounted price;
collecting a card revenue generated from said selling said consolidated gift card;
giving at least a first portion of said revenue to a community group; and
keeping at least a second portion of said revenue.

9. The method of claim 8, wherein said method is performed by a facilitator, said facilitator selected from a group comprised of a single entity and a plurality of entities.

10. The method of claim 9, wherein said facilitator performs all steps of said method, said facilitator performs a first portion of said method and directs one or more other entities to perform a second portion of said method, or said facilitator direct one or more other entities to perform said method.

11. The method of claim 8, wherein said consolidating the outstanding balances to a consolidated gift card step is performed by a method comprising the steps of: receiving each of said at least one gift card in a secure depository or designated location; reading a value associated with each of said at least one gift card, arriving at a sum gift card value for a plurality of said at least one gift card; associating at least one sum gift card value with each of said at least one gift card; and discounting said sum gift card value to arrive at a consolidated gift card face value.

12. The method of claim 8, wherein said selling said consolidated gift card step is performed by a method selected from a group comprised of selling said consolidated gift card at a store, selling said consolidated gift card to at least one member of said community group, auctioning said consolidated gift card, and selling said consolidated gift card as part of a promotional campaign in which said at least one gift card was received, and selling said consolidated gift card on-line.

13. The method of claim 8, wherein said consolidated gift card is sold at a discounted value between approximately fifty percent and approximately ninety-nine percent of said consolidated gift card's value.

14. A method comprising the steps of:
receiving at least one gift card, each of said at least one gift card having an outstanding balance;
consolidating at least one of said outstanding balance to a consolidated gift card, said consolidating at least one of said outstanding balance to a consolidated gift card step is performed by:
receiving each of said at least one gift card in a secure depository or designated location;
reading a value associated with each of said at least one gift card;
arriving at a sum gift card value for a plurality of said at least one gift card;
associating at least one sum gift card value with each of said at least one gift card; and
discounting said sum gift card value to arrive at said consolidated gift card face value with a discounted value;
selling said consolidated gift card;
collecting a card revenue generated from said selling said consolidated gift card; and
giving at least a portion of said revenue to a community group.

15. The method of claim 14, wherein said method is performed by a facilitator, said facilitator selected from a group comprised of a single entity and a plurality of entities.

16. The method of claim 15, wherein said facilitator performs all steps of said method, said facilitator performs a first portion of said method and directs one or more other entities to perform a second portion of said method, or said facilitator direct one or more other entities to perform said method.

17. The method of claim 14, wherein said selling said consolidated gift card step is performed by a method selected from a group comprised of selling said consolidated gift card at a store, selling said consolidated gift card to at least one member of said community group, auctioning said consolidated gift card, and selling said consolidated gift card as part of a promotional campaign in which said at least one gift card was received, and selling said consolidated gift card on-line.

18. The method of claim 14, wherein said discounted value is between approximately fifty percent and approximately ninety nine of said consolidated gift card's value.

19. The method of claim 14, wherein said method further includes the step of keeping at least a portion of said revenue.
